(19) United States
(12) Patent Application Publication
(10) Pub. No.: US 2024/0246093 A1
(43) Pub. Date: Jul. 25, 2024

(54) DRIVE FOR A SAMPLE CARRIER

(71) Applicant: Testo bioAnalytics GmbH, Titisee-Neustadt (DE)

(72) Inventor: Markus MÜNZER, Hinterzarten (DE)

(73) Assignee: Testo bioAnalytics GmbH, Titisee-Neustadt (DE)

(21) Appl. No.: 18/413,554

(22) Filed: Jan. 16, 2024

(30) Foreign Application Priority Data
Jan. 20, 2023 (DE) 102023101478.1

(51) Int. Cl. B04B 5/04; B04B 9/12

(52) U.S. Cl. CPC B04B 5/0421; B04B 9/12

(57) ABSTRACT

A rotary plate (1) of a centrifuge (2) having a pivoting plate (3) mounted thereon is provided, to carry out a rotational and/or pivoting movement of the pivoting plate (3) relative to the rotary plate (1). This allows the rotary plate (1) to be drivable by a drive (5) rotationally decoupled from the rotary plate (1).

### CROSS-REFERENCE TO RELATED APPLICATIONS

This application claims priority from German Patent Application No, 10 2023 101 478.1, filed Jan. 20, 2023, which is incorporated herein by reference as if fully set forth.

### TECHNICAL FIELD

The invention relates to a rotary plate of a centrifuge having at least one pivoting plate mounted thereon.

The invention furthermore relates to a centrifuge having a rotary plate according to the invention.

The invention furthermore relates to a method for rotating and/or pivoting at least one pivoting plate arranged on a rotary plate of a centrifuge.

### BACKGROUND

Such rotary plates are known and are used, for example, in the field of microfluidics. In this case, a microfluidic arrangement can be placed on the rotary plate and is subjected to a force by the rotation of the rotary plate in the centrifuge. The direction of the force relative to the microfluidic arrangement can be determined here by the alignment of the pivoting plate. For example, the alignment of the pivoting plate can be set and then the centrifuge can be started. The force then acts on the microfluidic arrangement in a predetermined direction. However, in order to change the alignment of the pivoting plate, the centrifuge then has to be stopped. The pivoting plate may also be mounted in a spring-loaded manner such that the alignment of the microfluidic arrangement depends on the force acting on it and, for example, on the rotational speed of the rotary plate. However, this arrangement does not permit an arbitrary combination of rotational speed or force and alignment of the microfluidic arrangement.

### SUMMARY

It is the object of the invention to improve the use characteristics of rotary plates of this type.

To achieve the stated object, one or more of the features disclosed herein are provided according to the invention. In particular, in order to solve the stated object, in the case of rotary plates of the type described at the beginning it is thus proposed according to the invention that a rotational and/or pivoting movement of the pivoting plate relative to the rotary plate can be driven by a drive rotationally decoupled from the rotary plate.

The pivoting plates can therefore be adjusted independently of the rotational speed of the centrifuge. The pivoting plates can be adjusted while the centrifuge is in operation. In addition, the drive for the movement of the pivoting plate may be stationary. Forces acting on the drive are thus greatly reduced compared to a drive which is mounted on the rotary plate. The pivoting plate does not necessarily have to be in the form of a plate. The pivoting plate may also be a rotatable and/or pivotable clamp or clip.

In an advantageous refinement, it may be provided that a pivoting plate comprises a holder for a sample carrier.

Thus, a sample carrier may be arranged on a pivoting plate. For example, the sample carrier may comprise a microfluidic arrangement.

Alternatively or additionally, it may be provided that an alignment of the pivoting plate determines locking of the sample carrier to the pivoting plate.

Thus, a simple locking and/or release of the sample carrier to and/or from the pivoting plate can be carried out, for example by manually rotating the pivoting plate with the sample carrier.

In an advantageous refinement, it can be provided that a plurality of pivoting plates are connected to a drive rod by a gear, in particular a toothed gear. Alternatively or additionally, it can be provided that the pivoting plates are synchronously rotatable and/or pivotable.

Thus, a plurality or all of the pivoting plates can be moved in the same way. Experiments carried out using the rotary plate can thus satisfy quality assurance requirements.

In an advantageous refinement, it can be provided that a translational movement of the drive is converted by means of a gear into a rotational and/or pivoting movement, in particular of the pivoting plates.

Thus, for example, a lifting movement of a stationary drive can be used to drive a rotational and/or pivoting movement. Rotational and/or pivoting movements of the pivoting plates can be carried out independently of the rotation of the rotary plate. The translation vector of the drive can be guided parallel, in particular congruently, to the axis of rotation of the rotary plate. A mutual adverse effect of the translational movement of the drive and the rotational movement of the rotary plate can be reduced or avoided.

In an advantageous refinement, it can be provided that a spindle and a spindle nut are arranged on the axis of rotation of the rotary plate, one of said parts being fixed to the rotary plate and the other part being rotatable in the direction of rotation of the rotary plate.

Thus, a translational movement of one of the two parts mentioned can be converted into a rotational movement of one of the parts.

In an advantageous refinement, it can be provided that a rotational and/or pivoting movement of the pivoting plate can be driven by a rotational movement of the spindle and/or of the spindle nut.

Thus, a rotational movement of one of the two parts mentioned can drive a movement of the pivoting plate. The rotational movement of one of the two parts mentioned can be driven, for example, by a translational movement of one of the parts.

In an advantageous refinement, it can be provided that a preferably axial translational movement of a spindle and/or spindle nut arranged on the axis of rotation of the rotary plate can be driven by a translational movement of a drive rod rotationally decoupled from the rotary plate.

Thus, a stationary drive can be used to control the movement of the pivoting plates. The drive may, for example, move a drive rod lying on the axis of rotation of the rotary plate, the drive rod not having to be manufactured to be rotatable. It is also possible to use a translational movement of a part lying on the rotational axis of the rotary plate to adjust the movement of the pivoting plates independently of a rotation of the same part.

In an advantageous refinement, it can be provided that the rotational decoupling of the drive from the rotary plate is realized by a rolling bearing.

The rolling bearing may be a ball bearing. The rolling bearing may be axially loadable in order to transmit a translational movement to a rotating element on the rotary plate.

In an advantageous refinement, it may be provided that the pivoting plate and/or a sample carrier mounted on a holder of a pivoting plate are/is heatable.

Thus, the sample carriers can be temperature-controlled depending on the requirements of the treatments to be carried out on the samples.

As an alternative or in addition, the features of the further independent claim, which is directed to a centrifuge, are provided according to the invention for achieving the stated object. In particular, in order to achieve the stated object in the case of centrifuges of the type described at the beginning, it is thus proposed according to the invention that they have a rotary plate according to the invention.

Thus, the advantages of a rotary plate according to the invention can be used in a centrifuge.

As an alternative or in addition, in order to achieve the stated object, the features of the further independent claim, which is directed to a method for rotating and/or pivoting a pivoting plate arranged on a rotary plate of a centrifuge are provided according to the invention. In particular, in order to solve the stated object, in the case of a method of the type described at the beginning, it is thus proposed according to the invention that a rotational and/or pivoting movement of the pivoting plate is driven by a drive rotationally decoupled from the rotary plate.

Thus, a stationary drive can be used to determine a movement position of a pivoting plate. The pivoting plate can be rotated and/or pivoted during the operation of the centrifuge.

In an advantageous refinement, it can be provided that the rotational and/or pivoting movement of the pivoting plate is driven by a translational movement, in particular which translational movement is carried out by a drive rod and/or is a lifting movement.

Thus, a drive which drives a translational movement can be used. A drive which drives a rotational movement can be used to drive the rotary plate. The drive of the rotary plate and the drive of the pivoting plate are decoupled. In particular, a degree of translational freedom of a part can be used for the movement of the pivoting plates, while a degree of rotational freedom of the same part is occupied by the rotation of the rotary plate and/or drives said rotation.

### BRIEF DESCRIPTION OF THE DRAWINGS

The invention will now be described in more detail with reference to an exemplary embodiment, but is not restricted to the exemplary embodiment. Further exemplary embodiments emerge from combining the features of individual or multiple claims with one another and/or with individual or multiple features of the exemplary embodiment.

In the FIGURES:

FIG. 1 shows a schematic illustration of a rotary plate according to the invention.

### DETAILED DESCRIPTION

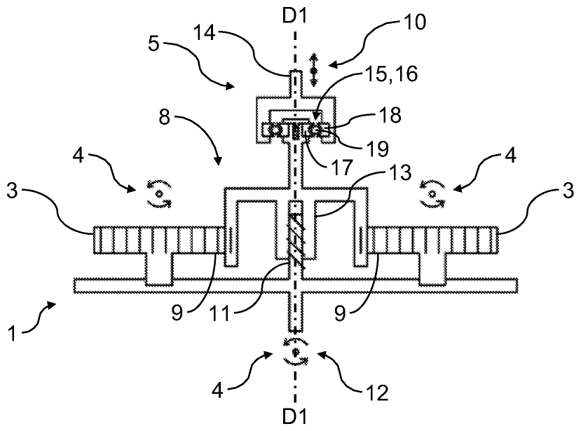

FIG. 1 shows schematically a rotary plate 1 according to the invention, which can be used with a centrifuge 2. Pivoting plates 3 are mounted on the rotary plate 1. A rotational movement 4 of the pivoting plates 3 relative to the rotary plate 1 can be driven by a drive 5 rotationally decoupled from the rotary plate 1. The pivoting plates 3 have a holder 6 for a sample carrier 7. The pivoting plate 3 and/or a sample carrier 7 mounted on a holder 6 of a pivoting plate 3 can be heatable. The pivoting plates 3 are connected via a gear 8, which is in the form of a toothed gear 9.

The gear 8 is designed in such a way that a translational movement 10 of the drive 5 leads to a rotational movement 4 of the pivoting plates 3. A spindle 11 which is fixed to the rotary plate 1 and a spindle nut 13 which is rotatable in the direction of rotation 12 of the rotary plate 1 are arranged on the axis of rotation D1 of the rotary plate 1. The gear is further designed in such a way that a rotational movement 4 of the pivoting plates 3 can be driven by a rotational movement 4 of the spindle nut 13. The rotational movement 4 of the spindle nut 13 is caused by an axial translational movement 10 of the spindle nut 13, which is driven by a translational movement 10, in this case a lifting movement, of a drive rod 14 rotationally decoupled from the rotary plate 1.

The rotary decoupling of the drive 5 from the rotary plate 1 is realized by a rolling bearing 15. The rolling bearing 15 is in the form of an axial ball bearing 16 with an inner ring 17, an outer ring 18 and balls 19.

### LIST OF REFERENCE SIGNS

1 rotary plate
2 centrifuge
3 pivoting plate
4 rotational movement
5 drive
6 holder
7 sample carrier
8 gear
9 toothed gear
10 translational movement
11 spindle
12 direction of rotation
13 spindle nut
14 drive rod
15 rolling bearing
16 axial ball bearing
17 inner ring
18 outer ring
19 balls
D1 axis of rotation

1. A rotary plate arrangement of a centrifuge (2), the rotary plate arrangement comprising:
a rotary plate;
at least one pivoting plate (3) mounted on the rotary plate;
wherein at least one of a rotational or pivoting movement (4) of the pivoting plate (3) relative to the rotary plate (1) is adapted to be driven by a drive (5) that is rotationally decoupled from the rotary plate (1).

2. The rotary plate arrangement as claimed in claim 1, wherein the pivoting plate (3) comprises a holder (6) for a sample carrier (7).

3. The rotary plate arrangement as claimed in claim 1, wherein the at least one pivoting plate comprises a plurality of pivoting plates (3) that are connected to one another by a gear (8), and the pivoting plates (3) are synchronously rotatable and/or pivotable.

4. The rotary plate arrangement as claimed in claim 3, further comprising a gear (9) that is adapted to convert a translational movement (10) of the drive (5) into the rotational and/or pivoting movement (4) of the pivoting plates (3).

5. The rotary plate arrangement as claimed in claim 1, further comprising a spindle (11) and a spindle nut (13) arranged on an axis of rotation (D1) of the rotary plate (1), one of said spindle or spindle nut (11, 13) being fixed to the rotary plate (1) and the other of said spindle or spindle nut(11, 13) being rotatable in a direction of rotation (12) of the rotary plate (1).

6. The rotary plate arrangement as claimed in claim 5, wherein the rotational and/or pivoting movement (4) of the pivoting plate (3) is driveable by a rotational movement (4) of the spindle (11) and/or of the spindle nut (13).

7. The rotary plate arrangement as claimed in claim 5, wherein a translational movement (10) of the spindle (11) and/or the spindle nut (13) arranged on the axis of rotation (D1) of the rotary plate (1) is driveable by a translational movement (10) of a drive rod (14) rotationally decoupled from the rotary plate (1).

8. The rotary plate arrangement as claimed in claim 7, wherein the rotational decoupling of the drive (5) from the rotary plate (1) is realized by a rolling bearing (15).

9. The rotary plate arrangement as claimed in claim 1, wherein at least one of the pivoting plate (3) or a sample carrier (7) mounted on a holder (6) of the pivoting plate (3) is heatable.

10. A centrifuge (2) comprising a rotary plate arrangement as claimed in claim 1.

11. A method for rotating and/or pivoting a pivoting plate (3) arranged on a rotary plate (1) of a centrifuge (2), the method comprising driving a rotational and/or pivoting movement of the pivoting plate (3) by a drive (5) that is rotationally decoupled from the rotary plate (1).

12. The method as claimed in claim 11, wherein the rotational and/or pivoting movement of the pivoting plate (3) is driven by a translational movement.

13. The method of claim 12, wherein the translational movement is carried out by a drive rod (14).

14. The method of claim 12, wherein the translational movement is a lifting movement.

15. The rotary plate arrangement of claim 2, wherein an alignment of the pivoting plate (3) determines locking of the sample carrier (7) to the pivoting plate (3).
